(19) United States
(12) Patent Application Publication
(10) Pub. No.: US 2024/0330332 A1
(43) Pub. Date: Oct. 3, 2024

(54) METHOD AND APPARATUS FOR PROVIDING RECOMMENDATIONS DURING EVIDENCE COLLECTION

(71) Applicant: MOTOROLA SOLUTIONS, INC., CHICAGO, IL (US)

(72) Inventors: BING QIN LIM, BAYAN LEPAS (MY); KOK BEE LEE, BALIK PULAU (MY); WAN PENG WOO, GELUGOR (MY); SHYAN JENQ HO, BAYAN LEPAS (MY)

(21) Appl. No.: 18/190,554

(22) Filed: Mar. 27, 2023

(51) Int. Cl. G06F 16/332; G06Q 50/26

(52) U.S. Cl. CPC G06F 16/3326; G06Q 50/26

(57) ABSTRACT

A method and apparatus for providing recommendations for evidence collection is provided herein. During operation a recommendation server is provided with evidence collected, including IoT device logs of events that can be used as evidence to investigate a particular crime. In response, the recommendation server will provide the investigator recommendations to search for additional evidence of events and objects that could potentially be used in a successful prosecution of the crime. The recommendations provided will be based on events that were used as evidence in past successful prosecutions of similar crimes.

### BACKGROUND

The Internet of Things (IoT) refers to the connection of every-day devices to the internet. Devices such as cars, kitchen appliances, medical devices, doors, windows, HVAC systems, drones, lights . . . , etc. can all be connected through the IoT. Basically, anything that can be powered can be connected to the internet to control its functionality and log its use. The IT allows objects to be sensed or controlled remotely across existing network infrastructure, creating opportunities for more direct integration of the physical world into computer-based systems, and resulting in improved efficiency, accuracy, and control. Along with controlling and sensing devices, the IoT also provides for tracking and logging the use of IoT devices. For example, a point of ingress or egress may have its use logged to see who is entering and leaving an area, an HVAC system may have its use logged so that the use of energy may be tracked, an automobile may have its use logged so that insurance companies may provide lower rates for those who drive safely, . . . , etc. With the multitude of IoT device logs potentially available to investigators, it would be beneficial to have a recommendation system to provide suggestions on evidence collection based on the IoT logs available.

### BRIEF DESCRIPTION OF THE SEVERAL VIEWS OF THE DRAWINGS

In the accompanying figures similar or the same reference numerals may be repeated to indicate corresponding or analogous elements. These figures, together with the detailed description, below are incorporated in and form part of the specification and serve to further illustrate various embodiments of concepts that include the claimed invention, and to explain various principles and advantages of those embodiments.

FIG. 1 illustrates a general operational environment for the present invention.

FIG. 2 illustrates a recommendation provided to an investigator.

FIG. 3 illustrates a general operational environment for the present invention in accordance with an alternate embodiment of the present invention.

FIG. 4 is a block diagram of the recommendation server of FIG. 1 and FIG. 3.

FIG. 5 is a flow chart showing operation of the recommendation server of FIG. 3.

Skilled artisans will appreciate that elements in the figures are illustrated for simplicity and clarity and have not necessarily been drawn to scale. For example, the dimensions of some of the elements in the figures may be exaggerated relative to other elements to help improve understanding of embodiments of the present disclosure.

The apparatus and method components have been represented where appropriate by conventional symbols in the drawings, showing only those specific details that are pertinent to understanding the embodiments of the present disclosure so as not to obscure the disclosure with details that will be readily apparent to those of ordinary skill in the art having the benefit of the description herein.

### DETAILED DESCRIPTION OF THE INVENTION

A method and apparatus for providing recommendations for evidence collection is provided herein. During operation a recommendation server is provided with evidence collected, including IoT device logs of events that can be used as evidence to investigate a particular crime. In response, the recommendation server will provide the investigator recommendations to search for additional evidence of events and objects that could potentially be used in a successful prosecution of the crime. The recommendations provided will be based on events that were used as evidence in past successful prosecutions of similar crimes.

In a further embodiment of the present invention, images from a crime scene can be provided to the recommendation server, and objects within those images can be determined by the recommendation server. The recommendation server will provide the investigator recommendations to search for additional evidence of events that could potentially be used in a successful prosecution of the crime. The recommendations provided will be based on objects that were used as evidence in past successful prosecutions of similar crimes.

As an example, consider a death investigation that might be a staged suicide. If an investigator provides a list of IoT devices within the crime scene, along with their log information, the recommender system can search past prosecutions for homicides to determine any evidence that helped in the past prosecution. A recommendation to search for additional evidence may be provided based on the comparison of the current investigation to the past prosecution. More particularly, events that were logged by the IoT devices at the current crime scene can be compared to events that were mentioned in prior prosecutions. If any important event from the prior prosecutions is missing from the events that were logged by the IoT device, a recommendation may be made to search for evidence of the missing event.

Expanding on the above, assume that IoT logs from IoT devices at a crime scene indicate the opening and closing of various doors at various times, however, does not mention a window being opened over a bathtub. Assume that a successful prosecution of a similar crime relied heavily on evidence that a window over a bathtub was left opened. A recommendation server will note the lack of evidence in the current crime scene, and instruct the investigator to look for evidence that the window over the bathtub was left open.

The method and apparatus for providing recommendations will be discussed in more detail below, starting with example system and device architectures of the system in which the embodiments may be practiced, followed by an illustration of processing blocks for achieving an improved technical method, device, and system for providing recommendations. Example embodiments are herein described with reference to flowchart illustrations and/or block diagrams of methods, apparatus (systems) and computer program products according to example embodiments. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. The methods and processes set forth herein need not, in some embodiments, be performed in the exact sequence as shown and likewise various blocks may be performed in parallel rather than in sequence. Accordingly, the elements of methods and processes are referred to herein as “blocks” or “steps.”

These computer program instructions may also be stored in a computer-readable memory that can direct a computer or other programmable data processing apparatus to function in a particular manner, such that the instructions stored in the computer-readable memory produce an article of manufacture including instructions which implement the function/act specified in the flowchart and/or block diagram block or blocks.

The computer program instructions may also be loaded onto a computer or other programmable data processing apparatus to cause a series of operational blocks to be performed on the computer or other programmable apparatus to produce a computer implemented process such that the instructions which execute on the computer or other programmable apparatus provide blocks for implementing the functions/acts specified in the flowchart and/or block diagram block or blocks. It is contemplated that any part of any aspect or embodiment discussed in this specification can be implemented or combined with any part of any other aspect or embodiment discussed in this specification. Further advantages and features consistent with this disclosure will be set forth in the following detailed description, with reference to the figures.

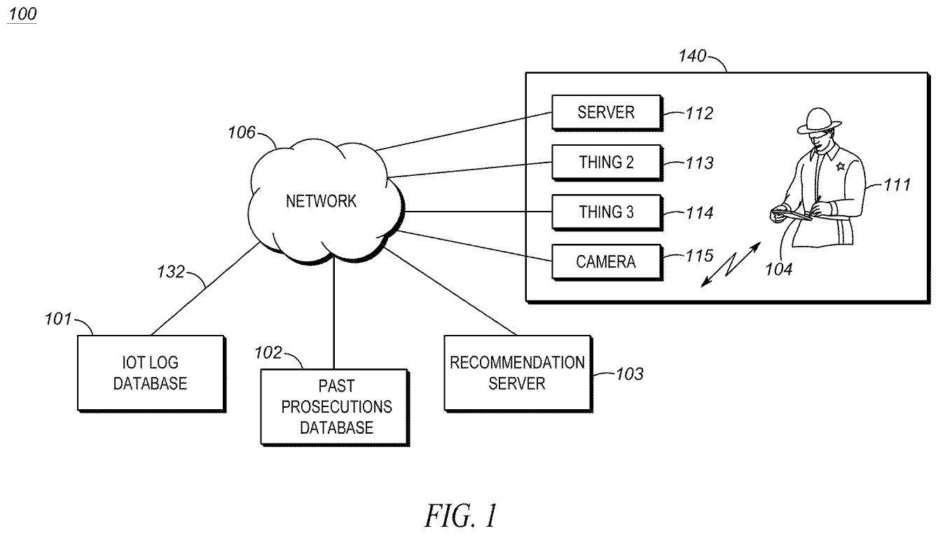

Referring now to the drawings, FIG. 1 illustrates an operational environment 100 where recommendations can be provided during evidence collection. Environment 100 includes one or more networks 106, IoT device 112, 113, 114, camera 115, IoT log database 101, past-prosecutions database 102, recommendation server 103, and smart device 104.

Network 106 may be a private or public network used for data exchange between devices. Communications through network 106 may take place via wired or wireless techniques. With this in mind, network 106 comprises a standard network configured to facilitate standard data transmission between devices connected to network 106. Network 106 comprises typical network elements such as base stations, base station controllers (BSCs), routers, switches, and the like, arranged, connected, and programmed to provide wired and wireless service to devices in a manner known to those of skill in the relevant art.

Smart device 104 may be any suitable computing and communication devices configured to engage in wired or wireless communication over network 106. Such communication may comprise standard cellular data. For example, smart device 112 may comprise a mobile device running an Android™ or iOS™ operating system and requesting and receiving recommendations from recommendation server 103. Camera 115 may comprise body-worn cameras worn by police officers that are located at the incident or crime scene.

As shown, environment 100 includes one or more IoT devices 112-114 using network 106 to store use information within IoT log database 101. As is known in the art, a particular communication protocol (IoT protocol) may be used for each IoT device. For example, various proprietary protocols such as DNP, Various IEC**** protocols (IEC 61850 etc. . . . ), bacnet, EtherCat, CANOpen, Modbus/Modbus TCP, EtherNet/IP, PROFIBUS, PROFINET, DeviceNet, . . . , etc. can be used. Also a more generic protocol such as Coap, SOAP, Mqtt, and RESTfull may also be used. Regardless of the protocol used, anytime IoT devices 112-114 are accessed or used, their use, along with the time of their use is logged in database 101 as use information. Such use information may include, but is not limited to a time the IoT device was used, a state of the IoT device before use (e.g., off, on, open, close, . . . , etc.), a state of the IoT device after use, a manner of use, along with any other information that may be provided by the IoT device (e.g., temperature from IoT temperature sensors, lighting conditions from IoT lights, biometric conditions from smart watches, . . . , etc.).

Past prosecutions database comprises a repository of prosecutions along with evidence collected during the investigation of those particular cases. The prosecution database can be stored at court or judiciary system, and comprises judiciary information of criminal cases, for example, whether a criminal case is successfully prosecuted, a prosecution's argument, a prosecution's jury's statement, and evidence submitted to the court by prosecutors that enabled the success of the prosecution. For example, a particular murder prosecution that was successful might include evidence such as, but not limited to fingerprints on doorknobs, entry and exit times of individuals for buildings, times that lights were turned on and off, blood stains on particular items or at particular locations, . . . etc. With the above in mind, prosecutions database serves as a repository for a type of crime prosecuted (e.g., murder, robbery, assault, battery, . . . , etc.), whether or not the prosecution for the crime was successful, and the types of evidence collected during the investigation of the crime.

Evidence stored in database 102 (e.g., digital evidence information for example evidence type, forensic analysis information, images, evidence owner, prosecution's statement related to the evidence etc) comprises evidence mentioned by the prosecutor in various criminal cases. This evidence may be weighted by importance. Specifically, this evidence can be weighted with an importance score based on the prosecution's argument and jury or judge statement during the trial (verbal audio by prosecutor and transcripted with speech to text processing by CCTV at the court, or text recorded by a court stenographer) and written digital prosecution's statement submitted to the judiciary system (digital case submission by prosecutor for the trial). For example, a higher weight may be given based on how many times the particular piece of evidence is mentioned at trial. The weighted important score of each piece of evidence is then taken into consideration when providing a recommendation. For example, providing an investigator with dozens of recommendations may overwhelm the investigator. Because of this, a smaller amount of recommendations may be provided to the investigator, comprising recommendations based on the highest-weighted evidence.

It should be noted that databases 101 and 102 are preferably stored in a single memory or exist on multiple entities and/or provided as a cloud service. Such memory may include any medium that is capable of storing information accessible by recommendation server 103. Such media may include machine-readable media, solid-state memories, magnetic media, and optical media, Read-Only Memory, Random Access Memory, flash memory, and the like.

Recommendation server 103 is preferably housed within a dispatch center (sometimes referred to as a public-safety access point (PSAP)) that is part of a computer-aided-dispatch center. Recommendation server 103 is configured to provide recommendations to officer 111 by communicating the recommendation to smart device 104. During operation, a type of crime, IoT logs from IoT devices 112-114, and potentially images from camera 115 are provided to recommendation server 103. This information can be manually entered by police officer 111 via device 104, or automatically provided to recommendation server 103 via direct the devices themselves.

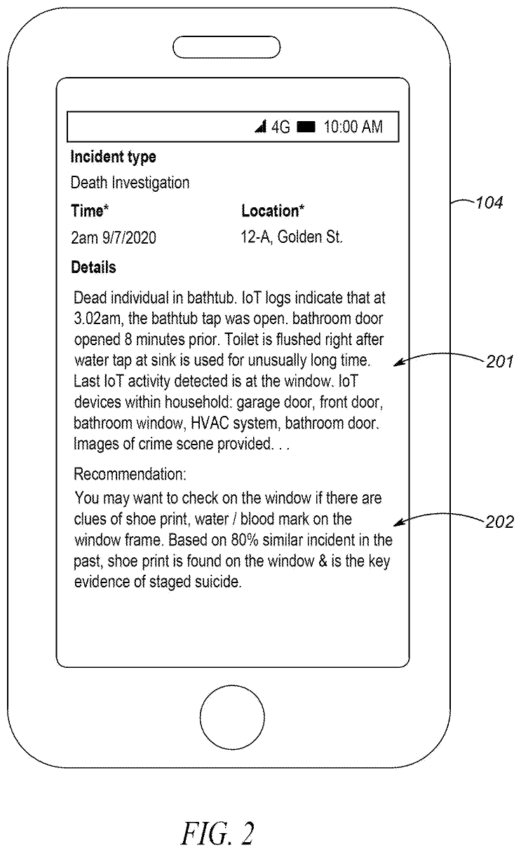

Recommendation server 103 accesses past prosecutions database 102 to determine evidence collected in past, similar crimes. A recommendation for additional investigation and/or evidence collection may be provided to the investigator by recommendation server sending the recommendation to device 104. The recommendation is based on a comparison of the current images and IoT device logs, and the evidence collected from past prosecutions of similar crimes. This is illustrated in FIG. 2.

As shown in FIG. 2, device 104 shows that investigator 111 has provided details about a particular death investigation 201 to recommendation server 103. These details may have been automatically provided to server 103. The details (IoT logs, crime type, and images) are used by recommendation server 103 to provide recommendation 202 to investigator 111.

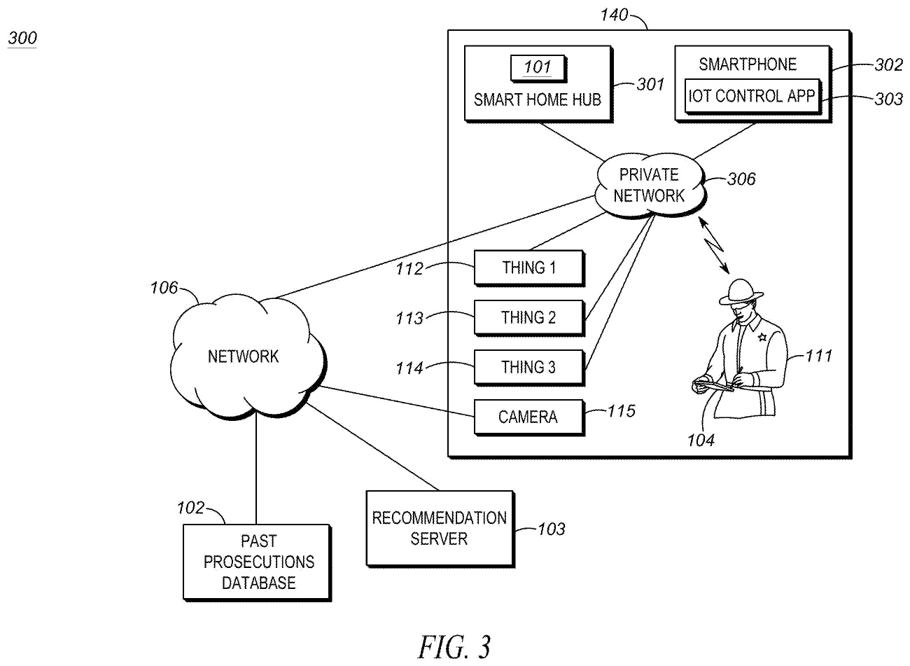

FIG. 3 illustrates an operational environment 300 where recommendations can be provided during evidence collection in accordance with an alternate embodiment. In the alternate embodiment, private network 306 (e.g., a private WiFi network) is provided, and comprises a private network within a house (e.g., crime scene 140) and interfacing to recommendation server 103 via public network 106.

In this example, crime scene 140 is equipped with a plurality of IoT devices 112, 113, and 114 that are connected to private network 306 (for example, a WIFI connection inside a house) and controlled via centralized smart home hub 301 (e.g., Apple® HomePod®). During the process of associating the IoT devices with home hub 301, the house owner will use an IoT control app 303 (e.g, Apple® HomeKit® app) on a smartphone 302 to set up and control the IoT devices, via the private network 306. In this example, smart home hub 301 will be logging all the activities of IoT devices with timestamps and the log can be accessed via the IoT control app 303 on, for example, a smartphone 302. During the IoT setup, the IoT control app 303 can prompt for pre-agreement to allow release of any home IoT activity log to recommendation server 103 when there are crimes detected, or simply requested by the police.

Once this pre-agreement and registration is done, IoT devices log will be released by smart home hub 301 automatically to the recommendation server 103 when a pre-agreed crime type happens in the house, or alternatively, when requested by the police. The IoT log database 101 can be referred to as the IoT devices log stored in IoT devices locally in smart home hub 301,

In the alternate embodiment, when smart home hub 301 detects or is notified of a crime that is in progress, or has happened, hub 301 will automatically release any IoT devices log to the recommendation server 103, complying according to the pre-agreement of house owner during IT system setup in his or her house. Based on the pre-agreement of the house owner in the smart house hub 301, a particular crime type triggers automatic release of IoT devices log of the house (based on incident location) that within a range of the incident time (for example, within time 12 am to 4 am because the incident time is 2 am) to the recommendation server 103. An example IoT devices log is shown below:
2.54 am—IoT Bathroom door OPEN
3.02 am—IoT Bathtub tap OPEN
3.05 am—IoT Water Tap at Sink OPEN
3.34 am—IoT Water Tap at Sink CLOSE
3.35 am—IoT Toilet Bowl FLUSH
3.42 am—IoT Window OPEN

Recommendation server 103 will then retrieve information of similar incidents (e.g., death incident) that happened in the past and prosecuted, 8 that were stored in past prosecution database 102 to compare to current IoT devices log, and non-IoT object images.

The IoT devices log is then analyzed in recommendation server 103 together with information retrieved from past prosecution databases and non-IoT object images. In this example, recommendation server 103 found 10 past successfully prosecuted murder cases that have similar IoT device log (similar IoT of bathtub, water tap, toilet bowl, toilet window being triggered during murder and similar IoT triggered time sequences and duration) and similar non-IoT devices (similarly having a bathtub, a sink and a toilet window) with current death incident. Out of the 10 past successfully prosecuted murder cases, 8 of the cases have evidence of at least one shoe print, watermark, or blood mark at the window frame. Among the evidence of shoe print, watermark, and blood mark at window frame, evidence of the shoe print has a highest aggregated weighted important score. A recommendation to check on the window to see if there are clues of a shoe print.

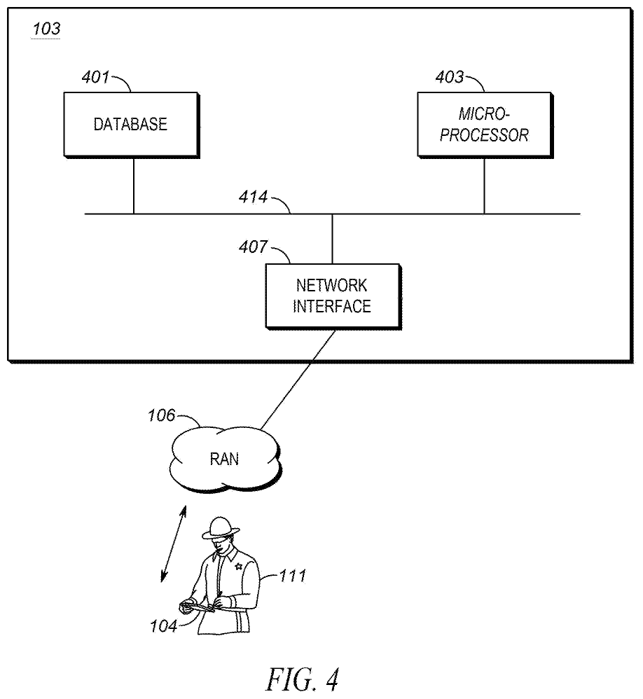

FIG. 4 is a block diagram of the recommendation server of FIG. 1 and FIG. 3. Recommendation server 103 may include various components connected by bus 414. Recommendation server 103 may include a hardware processor (logic circuitry) 403 such as one or more central processing units (CPUs) or other processing circuitry able to provide any of the functionality described herein when running instructions (computer code, computer programs, . . . , etc.). Logic circuitry 403 may be connected to memory 401 that may include a non-transitory machine-readable medium, on which is stored one or more sets of instructions/computer code. Memory 401 may include one or more of static or dynamic storage, or removable or non-removable storage, for example. A machine-readable medium may include any medium that is capable of storing, encoding, or carrying instructions for execution by processor 403, such as solid-state memories, magnetic media, and optical media. Machine-readable media may include, for example, Electrically Programmable Read-Only Memory (EPROM), Random Access Memory (RAM), or flash memory. In addition to storing instructions for logic circuitry 403, in an alternate embodiment of the present invention memory 401 may also be configured to store the information within databases 101 and 102, thus having a more-centralized system.

The instructions stored in memory 401 enable recommendation server 103 to operate in any manner thus programmed, such as the functionality described specifically herein, when processor 403 executes the instructions. The machine-readable medium may be stored as a single medium or in multiple media, in a centralized or distributed manner. In some embodiments, instructions may further be transmitted or received over a communications network via a network interface 407 utilizing any one of a number of transfer protocols (e.g., frame relay, internet protocol (IP), transmission control protocol (TCP), user datagram protocol (UDP), hypertext transfer protocol (HTTP), etc.).

Network interface 407 may thus enable recommendation server 103 to receive any of the IoT logs, images, or past prosecutions data described above through network 106 via wired or wireless communication. Network interface 407 may include electronic components such as a transceiver that enables serial or parallel communication. The wireless connections may use one or more protocols, including Institute of Electrical and Electronics Engineers (IEEE) Wi-Fi 802.11. Long Term Evolution (LTE)/4G, 5G, Universal Mobile Telecommunications System (UMTS), or peer-to-peer (P2P), for example, or short-range protocols such as Bluetooth, Zigbee, or near field communication (NFC). Wireless communication may occur in one or more bands, such as the 800-900 MHz range, 1.8-1.9 GHz range, 2.3-2.4 GHz range, 60 GHz range, and others, including infrared (IR) communications. Example communication networks to which recommendation server 103 may be connected via network interface 407 may include a local area network (LAN), a wide area network (WAN), a packet data network (e.g., the Internet), mobile telephone networks (e.g., cellular networks), and wireless data networks.

During operation, recommendations are provided to user 111 based on events logged at the crime scene, and potentially images captured of the crime scene. IoT log information is received from IoT log database 101. Images are received from any cameras at the crime scene. Logic circuitry 403 stores the IoT logs in memory 401 and determines events (e.g., window opening, garage door opening, HVAC system triggered, door closed, . . . , etc) along with objects identified within the received images (e.g., bathtub, window, razor, weapon, . . . , etc.). Once the list is created, past prosecutions database 102 is accessed to determine if there are any successful prosecutions of similar cases. For example, are there any past prosecutions for similar cases that involve similar events and objects identified within the received images. If a case type is provided to recommendation server by officer 111 (e.g., death investigation, burglary, . . . , etc.), the past prosecutions database 102 may be searched for similar case types having similar IoT devices and objects identified. Once similar cases have been found, logic circuitry 403 then determines evidence that was mentioned in those cases that has not been mentioned in the current investigation.

With the above in mind, recommendation server 103 comprises an apparatus comprising a network interface configured to receive IoT device logs from IoT devices that exist at a scene of a particular crime, the network interface also configured to receive a list of evidence used in past prosecutions for crimes similar to the particular crime, wherein the IoT device logs comprise logs of events that happened at the crime scene that were detected by the IoT devices, and the list of evidence used in past prosecutions comprises a list of events that were mentioned in the past prosecutions.

A processor is provided that executes code that instructs the processor to receive the IoT device logs from the network interface, receive the list of evidence used in the past prosecutions, compare the events that happened at the crime scene to the events that were mentioned in the evidence used in the past prosecutions, and provide a recommendation to a user to search for particular evidence based on the comparison.

As discussed above, the processor also executes code that instructs the processor to, weight the evidence used in the past prosecutions based on how often the evidence was mentioned during trial, and wherein the recommendation comprises a recommendation to search for particular evidence that was mentioned the most at trial.

Additionally, the recommendation may comprise a recommendation to search for evidence of events that were mentioned in the evidence used in the past prosecutions but were not mentioned in the events that happened at the crime scene.

When a camera is available at the crime scene, the network interface may also be configured to receive images from cameras that exist at the scene of the particular crime, and the list of evidence used in past prosecutions for similar crimes comprises a list of objects that were mentioned in the past prosecutions. The processor also executes code that instructs the processor to receive the images from the network interface, identify objects within the images, compare the identified objects to objects that were mentioned in the evidence used in the past prosecutions, and provide a recommendation to a user to search for particular evidence based on the comparison. The recommendation may comprises a recommendation to search for objects that were mentioned in the evidence used in the past prosecutions but that were not identified in the images from the crime scene.

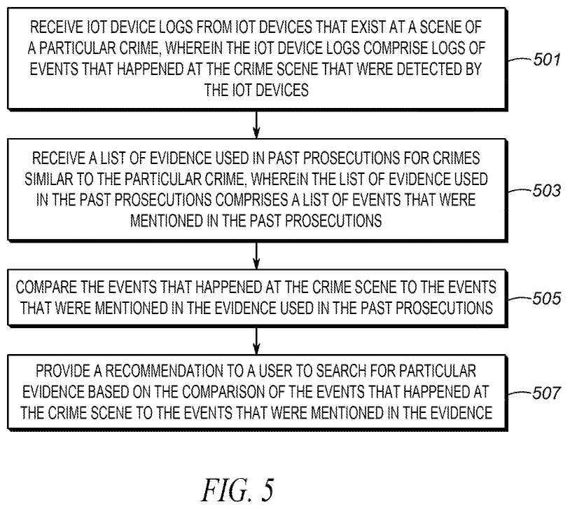

FIG. 5 is a flow chart showing operation of the recommendation server of FIG. 4. 10. The logic flow begins at step 501 where logic circuitry 403 receives IoT device logs from IoT devices that exist at a scene of a particular crime, wherein the IoT device logs comprise logs of events that happened at the crime scene that were detected by the IoT devices. At step 503, logic circuitry accesses memory and receives a list of evidence used in past prosecutions for crimes similar to the particular crime, wherein the list of evidence used in the past prosecutions comprises a list of events that were mentioned in the past prosecutions. At step 505, logic circuitry 403 compares the events that happened at the crime scene to the events that were mentioned in the evidence used in the past prosecutions. Finally, at step 507, logic circuitry provides a recommendation to a user to search for particular evidence based on the comparison of the events that happened at the crime scene to the events that were mentioned in the evidence.

As discussed above, the evidence used in the past prosecutions may be weighted based on how often the evidence was mentioned during trial, and the recommendation comprises a recommendation to search for particular evidence that was mentioned the most at trial.

Additionally, the recommendation may comprise a recommendation to search for evidence of events that were mentioned in the evidence used in the past prosecutions but were not mentioned in the events that happened at the crime scene.

Additionally, the list of evidence used in past prosecutions for similar crimes may comprise a list of objects that were mentioned in the past prosecutions and images may be received from cameras that exist at the scene of the particular crime, objects may be identified within the images and the identified objects may be compared to objects that were mentioned in the evidence used in the past prosecutions. When this happens, the recommendation also comprises a recommendation to the user to search for particular evidence based on the comparison of the identified objects to the objects that were mentioned in the evidence.

Additionally, the recommendation may comprise a recommendation to search for objects that were mentioned in the evidence used in the past prosecutions but that were not identified in the images from the crime scene.

Finally, the step of comparing the events that happened at the crime scene to the events that were mentioned in the evidence used in the past prosecutions, comprises comparing an IoT device type, an IoT device operating state, a triggering time sequence of two or more IoT devices, and a triggering time duration of IoT device.

As should be apparent from this detailed description, the operations and functions of the electronic computing device are sufficiently complex as to require their implementation on a computer system, and cannot be performed, as a practical matter, in the human mind. Electronic computing devices such as set forth herein are understood as requiring and providing speed and accuracy and complexity management that are not obtainable by human mental steps, in addition to the inherently digital nature of such operations (e.g., a human mind cannot interface directly with RAM or other digital storage, cannot transmit or receive electronic messages, electronically encoded video, electronically encoded audio, etc., and cannot provide as accurate and timely recommendation, among other features and functions set forth herein).

In the foregoing specification, specific embodiments have been described. However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of present teachings. The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

Moreover in this document, relational terms such as first and second, top and bottom, and the like may be used solely to distinguish one entity or action from another entity or action without necessarily requiring or implying any actual such relationship or order between such entities or actions. The terms “comprises,” “comprising,” “has”, “having,” “includes”, “including,” “contains”, “containing” or any other variation thereof, are intended to cover a non-exclusive inclusion, such that a process, method, article, or apparatus that comprises, has, includes, contains a list of elements does not include only those elements but may include other elements not expressly listed or inherent to such process, method, article, or apparatus. An element proceeded by “comprises . . . a”, “has . . . a”, “includes . . . a”, “contains . . . a” does not, without more constraints, preclude the existence of additional identical elements in the process, method, article, or apparatus that comprises, has, includes, contains the element. The terms “a” and “an” are defined as one or more unless explicitly stated otherwise herein. The terms “substantially”, “essentially”, “approximately”, “about” or any other version thereof, are defined as being close to as understood by one of ordinary skill in the art, and in one non-limiting embodiment the term is defined to be within 10%, in another embodiment within 5%, in another embodiment within 1% and in another embodiment within 0.5%. The term “one of”, without a more limiting modifier such as “only one of”, and when applied herein to two or more subsequently defined options such as “one of A and B” should be construed to mean an existence of any one of the options in the list alone (e.g., A alone or B alone) or any combination of two or more of the options in the list (e.g., A and B together).

A device or structure that is “configured” in a certain way is configured in at least that way, but may also be configured in ways that are not listed.

The terms “coupled”, “coupling” or “connected” as used herein can have several different meanings depending in the context in which these terms are used. For example, the terms coupled, coupling, or connected can have a mechanical or electrical connotation. For example, as used herein, the terms coupled, coupling, or connected can indicate that two elements or devices are directly connected to one another or connected to one another through an intermediate elements or devices via an electrical element, electrical signal or a mechanical element depending on the particular context.

It will be appreciated that some embodiments may be comprised of one or more generic or specialized processors (or “processing devices”) such as microprocessors, digital signal processors, customized processors and field programmable gate arrays (FPGAs) and unique stored program instructions (including both software and firmware) that control the one or more processors to implement, in conjunction with certain non-processor circuits, some, most, or all of the functions of the method and/or apparatus described herein. Alternatively, some or all functions could be implemented by a state machine that has no stored program instructions, or in one or more application specific integrated circuits (ASICs), in which each function or some combinations of certain of the functions are implemented as custom logic. Of course, a combination of the two approaches could be used.

Moreover, an embodiment can be implemented as a computer-readable storage medium having computer readable code stored thereon for programming a computer (e.g., comprising a processor) to perform a method as described and claimed herein. Any suitable computer-usable or computer readable medium may be utilized. Examples of such computer-readable storage mediums include, but are not limited to, a hard disk, a CD-ROM, an optical storage device, a magnetic storage device, a ROM (Read Only Memory), a PROM (Programmable Read Only Memory), an EPROM (Erasable Programmable Read Only Memory), an EEPROM (Electrically Erasable Programmable Read Only Memory) and a Flash memory. In the context of this document, a computer-usable or computer-readable medium may be any medium that can contain, store, communicate, propagate, or transport the program for use by or in connection with the instruction execution system, apparatus, or device.

Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation. For example, computer program code for carrying out operations of various example embodiments may be written in an object oriented programming language such as Java, Smalltalk, C++, Python, or the like. However, the computer program code for carrying out operations of various example embodiments may also be written in conventional procedural programming languages, such as the “C” programming language or similar programming languages. The program code may execute entirely on a computer, partly on the computer, as a stand-alone software package, partly on the computer and partly on a remote computer or server or entirely on the remote computer or server. In the latter scenario, the remote computer or server may be connected to the computer through a local area network (LAN) or a wide area network (WAN), or the connection may be made to an external computer (for example, through the Internet using an Internet Service Provider).

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separately claimed subject matter.

The invention claimed is:

1. An apparatus comprising:
a network interface configured to receive IT device logs from IoT devices that exist at a scene of a particular crime, the network interface also configured to receive a list of evidence used in past prosecutions for crimes similar to the particular crime, wherein the IoT device logs comprise logs of events that happened at the crime scene that were detected by the IoT devices, and the list of evidence used in past prosecutions comprises a list of events that were mentioned in the past prosecutions;
a processor executing code that instructs the processor to:
receive the IoT device logs from the network interface;
receive the list of evidence used in the past prosecutions;
compare the events that happened at the crime scene to the events that were mentioned in the evidence used in the past prosecutions; and
provide a recommendation to a user to search for particular evidence based on the comparison of the events that happened at the crime scene to the events that were mentioned in the evidence.

2. The apparatus of claim 1 wherein the processor also executes code that instructs the processor to:
weight the evidence used in the past prosecutions based on how often the evidence was mentioned during trial; and
wherein the recommendation comprises a recommendation to search for particular evidence that was mentioned the most at trial.

3. The apparatus of claim 1 wherein the recommendation comprises a recommendation to search for evidence of events that were mentioned in the evidence used in the past prosecutions but were not mentioned in the events that happened at the crime scene.

4. The apparatus of claim 1:
wherein the network interface is also configured to receive images from cameras that exist at the scene of the particular crime, and the list of evidence used in past prosecutions for similar crimes comprises a list of objects that were mentioned in the past prosecutions;
wherein the processor also executes code that instructs the processor to:
receive the images from the network interface;
identify objects within the images;
compare the identified objects to objects that were mentioned in the evidence used in the past prosecutions; and
provide a recommendation to a user to search for particular evidence based on the comparison of the identified objects to the objects that were mentioned in the evidence.

5. The apparatus of claim 4 wherein the recommendation comprises a recommendation to search for objects that were mentioned in the evidence used in the past prosecutions but that were not identified in the images from the crime scene.

6. An apparatus comprising:
a network interface configured to receive IoT device logs from IoT devices that exist at a scene of a particular crime, the network interface also configured to receive a list of evidence used in past prosecutions for crimes similar to the particular crime, wherein the IoT device logs comprise logs of events that happened at the crime scene that were detected by the IoT devices, and the list of evidence used in past prosecutions comprises a list of events that were mentioned in the past prosecutions, wherein the network interface is also configured to receive images from cameras that exist at the scene of the particular crime, and the list of evidence used in past prosecutions for similar crimes comprises a list of objects that were mentioned in the past prosecutions;
a processor executing code that instructs the processor to:
receive the IoT device logs from the network interface;
receive the list of evidence used in the past prosecutions;
compare the events that happened at the crime scene to the events that were mentioned in the evidence used in the past prosecutions; and
receive the images from the network interface;
identify objects within the images;
compare the identified objects to objects that were mentioned in the evidence used in the past prosecutions;
provide a recommendation to a user to search for particular evidence based on the comparison of the events that happened at the crime scene to the events that were mentioned in the evidence; and
provide a recommendation to a user to search for particular evidence based on the comparison of the identified objects to the objects that were mentioned in the evidence.

7. The apparatus of claim 6 wherein the processor also executes code that instructs the processor to:
weight the evidence used in the past prosecutions based on how often the evidence was mentioned during trial; and
wherein the recommendation comprises a recommendation to search for particular evidence that was mentioned the most at trial.

8. The apparatus of claim 6 wherein the recommendation comprises a recommendation to search for evidence of events that were mentioned in the evidence used in the past prosecutions but were not mentioned in the events that happened at the crime scene.

9. The apparatus of claim 8 wherein the recommendation comprises a recommendation to search for objects that were mentioned in the evidence used in the past prosecutions but that were not identified in the images from the crime scene.

10. A method comprising the steps of:
receiving IoT device logs from IoT devices that exist at a scene of a particular crime, wherein the IoT device logs comprise logs of events that happened at the crime scene that were detected by the IoT devices;
receiving a list of evidence used in past prosecutions for crimes similar to the particular crime, wherein the list of evidence used in the past prosecutions comprises a list of events that were mentioned in the past prosecutions;
comparing the events that happened at the crime scene to the events that were mentioned in the evidence used in the past prosecutions; and
providing a recommendation to a user to search for particular evidence based on the comparison of the events that happened at the crime scene to the events that were mentioned in the evidence.

11. The method of claim 10 further comprising the steps of:
weighting the evidence used in the past prosecutions based on how often the evidence was mentioned during trial; and
wherein the recommendation comprises a recommendation to search for particular evidence that was mentioned the most at trial.

12. The method of claim 10 wherein the recommendation comprises a recommendation to search for evidence of events that were mentioned in the evidence used in the past prosecutions but were not mentioned in the events that happened at the crime scene.

13. The method of claim 10, wherein the list of evidence used in past prosecutions for similar crimes comprises a list of objects that were mentioned in the past prosecutions, and further comprising the steps of:
receiving images from cameras that exist at the scene of the particular crime;
identifying objects within the images;
comparing the identified objects to objects that were mentioned in the evidence used in the past prosecutions; and
wherein the recommendation also comprises a recommendation to the user to search for particular evidence based on the comparison of the identified objects to the objects that were mentioned in the evidence.

14. The method of claim 13 wherein the recommendation comprises a recommendation to search for objects that were mentioned in the evidence used in the past prosecutions but that were not identified in the images from the crime scene.

15. The method of claim 10, wherein the step of comparing the events that happened at the crime scene to the events that were mentioned in the evidence used in the past prosecutions, comprises comparing an IoT device type, an IoT device operating state, a triggering time sequence of two or more IoT devices, and a triggering time duration of IoT device.
